(19) United States
(12) Patent Application Publication
(10) Pub. No.: US 2007/0135968 A1
(43) Pub. Date: Jun. 14, 2007

(54) Apparatus, system, and method for calculating maximum back pressure

(76) Inventors: Steven M. Bellinger, Columbus, IN (US); Patrick J. Shook, Franklin, IN (US); J. Steve Wills, Columbus, IN (US); Joan Wills, Nashville, IN (US)

Correspondence Address: KUNZLER & ASSOCIATES, 8 EAST BROADWAY, SUITE 600, SALT LAKE CITY, UT, 84111, US

(21) Appl. No.: 11/301,701

(22) Filed: Dec. 13, 2005

(51) Int. Cl. G05B 21/00

(52) U.S. Cl. 700/273

(57) ABSTRACT

An apparatus, system, and method are disclosed for calculating a maximum back pressure for a particulate filter. An identification module identifies a target pressure function for an air flow and a pressure of the filter. A projection module projects a high air flow for the target pressure function. A calculation module calculates a maximum back pressure from the target pressure function for the high air flow. In addition, a test module may regenerate the filter if the if the maximum back pressure exceeds a pressure threshold. In one embodiment, the pressure threshold is a specified back pressure limit wherein the specified back pressure limit is the greatest filter back pressure an engine can tolerate while delivering rated power.

### BACKGROUND OF THE INVENTION

1. Field of the Invention

This invention relates to engine back pressure and more particularly relates to calculating a maximum back pressure for an internal combustion engine.

2. Description of the Related Art

Environmental concerns have motivated the implementation of emission requirements for internal combustion engines throughout much of the world. Generally, emission requirements vary according to engine type. Emission tests for compression-ignition or diesel engines typically monitor the release of diesel particulate matter, nitrogen oxides, hydrocarbons, and carbon monoxide. Catalytic converters implemented in an exhaust gas after-treatment system have been used to eliminate many of the pollutants present in exhaust gas. However, to remove diesel particulate matter, a diesel particulate filter, herein referred to as a filter, must often be installed downstream from a catalytic converter, or in conjunction with a catalytic converter.

A typical filter comprises a porous ceramic matrix with parallel passageways through which exhaust gas passes. Particulate matter accumulates on the surface of the filter, creating a buildup that obstructs the flow of exhaust gas. The particulate obstruction creates a back pressure that can impair engine performance. Sufficient back pressure may prevent the engine from achieving a rated performance by the limiting the exhaust flow.

Various conditions, including, but not limited to, engine operating conditions, mileage, driving style, terrain, etc., affect the rate at which particulate matter accumulates within a diesel particulate filter. Common forms of particulate matter are ash and soot. Ash, typically a residue of burnt engine oil, is substantially incombustible and builds slowly within the filter. Soot, chiefly composed of carbon, can be oxidized and driven off of the filter in an event called regeneration. The filter may be periodically regenerated to drive off soot, reduce the particulate matter in the filter, and prevent the back pressure from impairing engine performance.

To regenerate or oxidize the accumulated soot, filter temperatures generally must exceed the temperatures typically reached at the filter inlet. Consequently, additional methods to initiate regeneration of a diesel particulate filter must be used. In one method, a react ant, such as diesel fuel, is introduced into an exhaust after-treatment system to generate temperature and initiate oxidation of soot in the filter. Partial or complete regeneration may occur depending on the duration of time the filter is exposed to elevated temperatures and the amount of soot remaining on the filter.

Regeneration traditionally has been initiated at set intervals, such as after a specified distance traveled or time elapsed. Interval based regeneration, however, has proven to be ineffective for several reasons. First, regenerating a particulate filter without sufficient particulate buildup lessens the fuel economy of the engine and exposes the particulate filter to unnecessary high temperature cycles and the resulting wear to the filter. Secondly, if the particulate matter accumulates significantly before the next regeneration, back pressure from the obstruction of the exhaust flow can negatively affect engine performance. The filter back pressure must not exceed a specified back pressure limit if the engine is to deliver a rated level of power.

Unfortunately, the accumulation of ash in the particulate filter changes the frequency that that the filter must be regenerated. Over time, more frequent regeneration is needed to remove the soot in the filter and prevent excessive back pressure. If the filter is not regenerated when the filter's maximum back pressure exceeds the specified back pressure limit, the filter will not support the rated engine performance. The primary complication is that the maximum back pressure cannot be measured—it must be projected. If the measured maximum back pressure were used, by the time the control module saw a back pressure that exceeded the rated threshold, the engine would already have a back pressure too high to achieve the certified power rating. However, if the filter is regenerated too frequently, fuel economy and filter life will decrease.

From the foregoing discussion, it should be apparent that a need exists for an apparatus, system, and method that calculates the maximum back pressure created by particulates in a filter at any operating point of the engine, even an operating point that is far removed from the highest engine air flow or exhaust flow rate. Beneficially, such an apparatus, system, and method would determine when to regenerate the filter to avoid exceeding a specified back pressure limit required for the rated engine performance.

### SUMMARY OF THE INVENTION

The present invention has been developed in response to the present state of the art, and in particular, in response to the problems and needs in the art that have not yet been fully solved by currently available back pressure calculation methods. Accordingly, the present invention has been developed to provide an apparatus, system, and method for calculating maximum back pressure that overcome many or all of the above-discussed shortcomings in the art.

The apparatus to calculate a maximum back pressure is provided with a plurality of modules configured to functionally execute the necessary steps of identifying a target pressure function for an air flow or exhaust flow and a pressure, projecting a high air flow for the target pressure function, and calculating a maximum back pressure. These modules in the described embodiments include an identification module, a projection module, and a calculation module.

The identification module identifies a target pressure function for an air flow and a pressure. In one embodiment, the identification module identifies the target pressure function from a plurality of pressure functions. The pressure functions may each comprise a plurality of air flow and pressure value pairs. The air flow/pressure value pairs may be experimentally measured. In an alternate embodiment, the air flow/pressure value pairs are derived from a mathematical model. The identification module may interpolate the target pressure function from a second and a third pressure function. In an alternate embodiment, the identification module calculates the first pressure function from the air flow and the pressure using an algorithm.

The projection module projects a high airflow forth target pressure function. In one embodiment, the high air flow is the minimum air flow required for a filter to support a rated engine performance. The projection module may project the high air flow by finding the air flow/pressure value pair of the target pressure function with an air flow substantially equal to the high air flow.

The calculation module calculates a maximum back pressure from the target pressure function for the high air flow. In one embodiment, the maximum back pressure is the pressure value for the air flow/pressure value pair of the target pressure function where the air flow is substantially equal to the high air flow.

In one embodiment, the apparatus further comprises a test module. The test module may regenerate the filter if the maximum back pressure exceeds a pressure threshold. The pressure threshold may be a specified back pressure limit that the filter cannot exceed to support the rated performance of an engine. The apparatus calculates the maximum back pressure for the filter. In addition, the apparatus may regenerate the filter if the maximum back pressure exceeds the pressure threshold.

A system of the present invention is also presented to calculate a maximum back pressure. The system may be embodied in an exhaust gas after-treatment system of a diesel engine. In particular, the system, in one embodiment, includes a filter, a pressure sensor module, an air-flow sensor module, and a controller. The controller further comprises an identification module, a projection module, and a calculation module.

The filter is configured to trap particulates from an exhaust gas. In one embodiment, the exhaust gas is from the exhaust gas after-treatment system of the diesel engine. The particulates may include a substantially incombustible ash and a substantially combustible soot. In one embodiment, the system includes a regeneration device. The regeneration device may regenerate the filter by injecting a react ant such as diesel fuel into the filter. The react ant may combust the soot in the filter, reducing the soot accumulation in the filter.

The pressure sensor module determines a pressure across the filter. In one embodiment, the pressure sensor module comprises a first pressure sensor disposed upstream of the filter and a second pressure sensor disposed downstream of the filter. The pressure sensor module may calculate the pressure as the difference in pressure between a first and second pressure sensor. In an alternate embodiment, the pressure sensor module estimates the pressure from a single pressure sensor. In a certain embodiment, the pressure sensor module estimates the pressure from one or more related engine parameters.

The air-flow sensor module determines an air flow through the filter. In one embodiment, the air-flow sensor module measures the air flow. In an alternate embodiment, the air-flow sensor module estimates the air flow from one or more related engine parameters such as fuel consumption.

The identification module identifies a target pressure function for the air flow and the pressure. The projection module projects a high air flow for the target pressure function. The calculation module calculates a maximum back pressure from the target pressure function for the high air flow. The system calculates the maximum back pressure for the filter to determine when the filter may be regenerated to support a rated engine performance.

A method of the present invention is also presented for calculating a maximum back pressure. The method in the disclosed embodiments substantially includes the steps necessary to carry out the functions presented above with respect to the operation of the described apparatus and system. In one embodiment, the method includes identifying a target pressure function for an air flow and a pressure, projecting a high air flow for the target pressure function, and calculating a maximum back pressure. The method also may include regenerating a filter if the maximum back pressure exceeds a pressure threshold.

An identification module identifies a target pressure function for an air flow and a pressure. A projection module projects a high air flow for the target pressure function. A calculation module calculates a maximum back pressure from the target pressure function for the high air flow. In addition, a test module may regenerate a filter if the if the maximum back pressure exceeds a pressure threshold. In one embodiment, the pressure threshold is a specified back pressure limit wherein the specified back pressure limit is the greatest back pressure an engine can tolerate while delivering a rated power.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention calculates a maximum back pressure for a filter. In addition, the embodiment of the present invention may regenerate the filter if the maximum back pressure exceeds a pressure threshold. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an exhaust gas after-treatment system in accordance with the present invention;

FIG. 2 is a schematic block diagram illustrating one embodiment of a control system of the present invention;

FIG. 3 is a schematic block diagram illustrating one embodiment of a back pressure module of the present invention;

FIG. 4 is a schematic block diagram illustrating another embodiment of a control system of the present invention;

FIG. 5A is a graph illustrating one embodiment of pressure functions of the present invention;

FIG. 5B is a graph illustrating one embodiment of identifying a target pressure function of the present invention;

FIG. 5C is a graph illustrating one embodiment of interpolating a target pressure function from a second and third pressure function of the present invention;

FIG. 5D is a graph illustrating one embodiment of calculating a maximum back pressure of the present invention;

FIG. 5E is a graph illustrating one embodiment of testing a maximum back pressure of the present invention;

FIG. 6 is a schematic flow chart diagram illustrating one embodiment of a maximum back pressure calculation method of the present invention;

FIG. 7 is a schematic block diagram illustrating one embodiment of a maximum back pressure calculation process of the present invention; and

FIG. 8 is a schematic flow chart diagram illustrating one embodiment of a regeneration method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal-bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

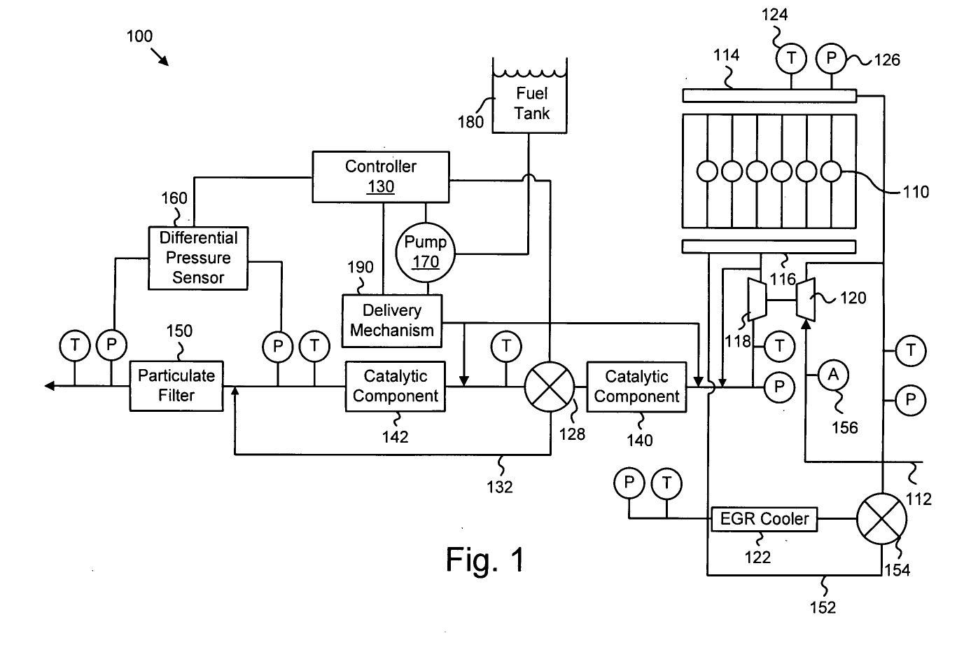

FIG. 1 depicts one embodiment of an exhaust gas after-treatment system 100 in accordance with the present invention. The exhaust gas after-treatment system 100 may be implemented in conjunction with an internal combustion engine 110 to remove various chemical compounds and particulates from emitted exhaust gas. As illustrated, the exhaust gas after-treatment system 100 may include an internal combustion engine 110, controller 130, catalytic components 140, 142, filter 150, differential pressure sensor 160, react ant pump 170, fuel tank 180, and reductant delivery mechanism 190. Exhaust gas treated in the exhaust gas after-treatment system 100 and released into the atmosphere consequently contains significantly fewer pollutants, such as diesel particulate matter, nitrogen oxides, hydrocarbons, and carbon monoxide than untreated exhaust gas.

The exhaust gas after-treatment system 100 may further include an air inlet 112, intake manifold 114, exhaust manifold 116, turbocharger turbine 118, turbocharger compressor 120, engine gas recirculation (EGR) cooler 122, temperature sensors 124, pressure sensors 126, air-flow sensors 156, and exhaust gas system valve 128. In one embodiment, an air inlet 112 vented to the atmosphere enables air to enter the exhaust gas after-treatment system 100. The air inlet 112 may be connected to an inlet of the intake manifold 114. The intake manifold 114 includes an outlet operatively coupled to the compression chamber of the internal combustion engine 110.

Within the internal combustion engine 110, compressed air from the atmosphere is combined with fuel to power the engine 110. Combustion of the fuel produces exhaust gas that is operatively vented to the exhaust manifold 116. From the exhaust manifold 116, a portion of the exhaust gas may be used to power a turbocharger turbine 118. The turbine 118 may drive a turbocharger compressor 120, which compresses engine intake air before directing it to the intake manifold 114.

At least a portion of the exhaust gases output from the exhaust manifold 116 is directed to the inlet of the exhaust gas after-treatment system valve 128. The exhaust gas may pass through one or more catalytic components 140, 142 and/or particulate filters 150 in order to reduce the number of pollutants contained in the exhaust gas before venting the exhaust gas into the atmosphere. Another portion of the exhaust gas may be re-circulated to the engine 110. In certain embodiments, the EGR cooler 122, which is operatively connected to the inlet of the intake manifold 114, cools exhaust gas in order to facilitate increased engine air inlet density. In one embodiment, an EGR valve 154 diverts the exhaust gas past the EGR cooler 122 through an EGR bypass 152.

Exhaust gas directed to the exhaust gas after-treatment system valve 128 may pass through the first catalytic component 140, such as a hydrocarbon oxidation catalyst or the like, in certain embodiments. Various sensors, such as temperature sensors 124, pressure sensors 126, and the like, maybe disposed throughout the exhaust gas after-treatment system 100 and may be in communication with the controller 130 to monitor operating conditions.

The exhaust gas after-treatment system valve 128 may direct the exhaust gas to the inlet of a second catalytic component 142, such as a nitrogen oxide adsorption catalyst or the like. Alternatively or in addition, a portion of the exhaust gas may be diverted through the system valve 128 to an exhaust bypass 132. The exhaust gas bypass 132 may have an outlet operatively linked to the inlet of a filter 150, which may comprise a particulate filter in certain embodiments. Particulate matter in the exhaust gas, such as soot and ash, may be retained within the filter 150. The exhaust gas may subsequently be vented to the atmosphere.

In addition to filtering the exhaust gas, the exhaust gas after-treatment system 100 may include a system for regenerating the filter 150. The regeneration system may introduce a react ant, such as fuel, into the exhaust gas or into components of the exhaust gas after-treatment system 100. The react ant may facilitate the regeneration of the filter 150 and may also facilitate the oxidation of various chemical compounds adsorbed within catalytic components 140, 142. The fuel tank 180, in one embodiment, may be connected to the react ant pump 170. The pump 170, under direction of the controller 130, may provide fuel or the like to a react ant delivery mechanism 190, such as a nozzle, to the catalytic components 140, 142. The react ant delivery mechanism 190 may also provide fuel to elsewhere in the system 100, including to the engine 110. The controller 130 may direct the exhaust valve 128, react ant pump 170, and react ant delivery mechanism 190 to create an environment conducive to combustion of soot.

One method to regenerate the filter 150, according to one embodiment, comprises periodically introducing react ant into the exhaust gas. The controller 130 directs the react ant pump 170 to deliver react ant to the react ant delivery mechanism 190. The controller 130 subsequently regulates the delivery mechanism 190 to deliver selected amounts of react ant into the exhaust gas. After each injection of react ant, the delivery mechanism 190 may be closed and no additional react ant is delivered directly to the exhaust gas. The effect of this sequence produces a series of injections of react ant into the inlet of the filter 150. As a result, the controller 130 may control the regeneration of the filter 150.

In certain embodiments, the exhaust gas after-treatment system 100 may be configured to determine an appropriate time to introduce react ant into the filter 150. Appropriate timing of regeneration may contribute to an increase in the fuel economy of the engine 110, extended life expectancy of the filter 150, and increased overall efficiency of the engine 110. Unfortunately, an appropriate timing of regeneration may ignore the need for the maximum back pressure of the filter 150 not to exceed a specified back pressure limit that cannot be exceeded if the engine 110 is to deliver a rated power. This is especially likely to be true later in the life cycle of the system when a significant amount of incombustible ash will have accumulated within the filter. The embodiment of the present invention calculates a maximum back pressure corresponding to a high air flow characteristic of the rated power. The present invention may in one embodiment regenerate the filter 150 to reduce the maximum back pressure below the specified back pressure limit, thus allowing the engine 110 to operate at the rated power.

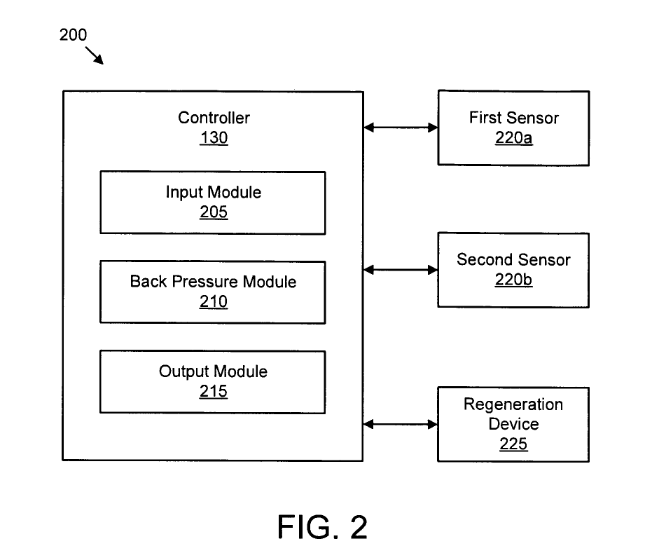

FIG. 2 illustrates one embodiment of a control system 200 in accordance with the present invention. As depicted, the system 200 may include a controller 130, one or more sensors 220, and a regeneration device 225. The controller 130 may include an input module 205, back pressure module 210, and output module 215. In addition, FIG. 2 may refer to one or more elements of FIG. 1.

The controller 130 is the controller 130 of FIG. 1. The input module 205 of the controller 130 may receive input from the sensors 220. The sensors 220 may be the temperature sensors 124, pressure sensors 126, air-flow sensors 156, and differential pressure sensor 160 of FIG. 1.

In one embodiment, the first sensor 220a is a pressure sensor that determines a pressure across the filter 150 of FIG. 1. In one embodiment, the first sensor module comprises the differential pressure sensor 160 with a first pressure sensor disposed upstream of the filter 150 and a second pressure sensor disposed downstream of the filter 150. The first sensor module 220a may calculate the pressure across the filter 150 as the difference in pressure between the first and second pressure sensor. In an alternate embodiment, the first sensor module 220a estimates the pressure across the filter 150 from a single pressure sensor 126 such as the pressure sensor 126 of FIG. 1.

In one embodiment, the second sensor module 220b is an air-flow sensor that determines an air flow through the filter 150. In one embodiment, the second sensor module 220b is the air-flow sensor 156 of FIG. 1 and measures the air flow. In an alternate embodiment, the second sensor module 220b estimates the air flow from one or more related parameters such as fuel consumption and/or engine speed.

The back pressure module 210 is configured to calculate a maximum back pressure of the filter 150. The output module 215 may be configured to control one or more devices such as the regeneration device 230. In one embodiment, the regeneration device 230 comprises the react ant pump 170, react ant delivery mechanism 190, exhaust gas system valve 128, and exhaust bypass 132 of FIG. 1. In a certain embodiment, the output module 215 controls the regeneration device 230 in response to directives from the back pressure module 210.

In a certain embodiment, the back pressure module 210 directs the regeneration of the filter 150 if the maximum back pressure exceeds a pressure threshold. The pressure threshold may be the specified back pressure limit for the engine 110 of FIG. 1. The engine 110 may only deliver rated power if the back pressure of the filter 150 does not exceed the specified back pressure limit. In an alternate embodiment, the pressure threshold is a percentage of the specified back pressure limit in the range of eighty to one hundred and twenty percent (80-120%).

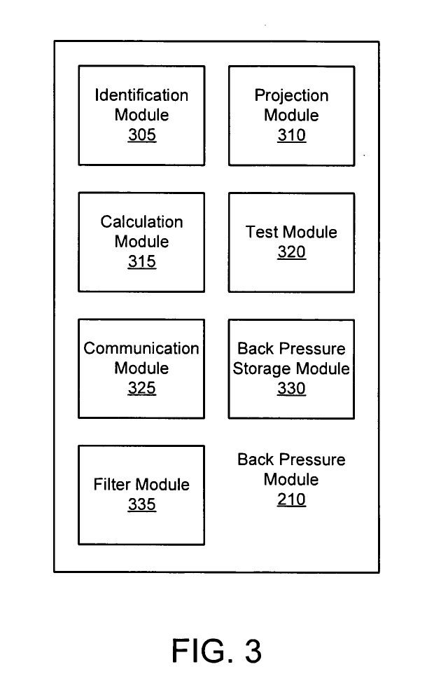

FIG. 3 is a schematic block diagram illustrating one embodiment of a back pressure module 210 of the present embodiment. The back pressure module 210 may be the back pressure module 210 of FIG. 2. As depicted, the back pressure module 210 includes an identification module 305, projection module 310, calculation module 315, test module 320, communication module 325, back pressure storage module 330, and filter module 335. In addition, FIG. 3 may refer to the elements of FIGS. 1-2.

The identification module 305 identifies a target pressure function for an air flow and a pressure. The pressure may be received from the first sensor 220a of FIG. 2. In addition, the air flow may be received from the second sensor 220b of FIG. 2. In one embodiment, the identification module 305 identifies the target pressure function from a plurality of pressure functions. In an alternate embodiment, the identification module derives the target pressure function from a mathematical model.

The projection module 310 projects a high air flow for the target pressure function. In one embodiment, the high air flow is the minimum air flow required for a filter 150 to support a rated engine performance for an engine 110 such as the filter 150 and engine 110 of FIG. 1. The high air flow may be specified for the engine 110 from experimental data. Alternatively, the high air flow may be derived from a model of engine 110 operation.

The calculation module 315 calculates a maximum back pressure from the target pressure function for the high air flow. The maximum back pressure is the expected filter 150 back pressure at the high air flow.

In one embodiment, the test module 320 directs the regeneration of the filter 150 if the maximum back pressure exceeds a pressure threshold. In a certain embodiment, the test module 320 directs the output module 215 of FIG. 2 to control the regeneration of the filter 150 using the regeneration device 230 of FIG. 2.

In one embodiment, the identification module 304, projection module 310, and calculation module 315 calculate a post-regeneration back pressure subsequent to regenerating the filter. The post-regeneration back pressure is the maximum back pressure for the high air flow with the filter regenerated. In one embodiment, the communication module 325 communicates a notice if the post-regeneration back pressure exceeds the pressure threshold. For example, the communication module 325 may communicate a notice that the filter 150 cannot support the rated engine performance. In an alternate example, the communication module 325 may communicate a notice that the filter 150 may need service or replacement.

In one embodiment, the filter module 335 filters the maximum back pressure with a stored back pressure. The back pressure storage module 330 may store a previous maximum back pressure value as the stored back pressure. For example, the calculation module 315 may calculate a first maximum back pressure instance at a first time. The back pressure storage module 330 may store the first maximum back pressure instance as the stored back pressure. The calculation module 315 may subsequently calculate a second maximum back pressure instance. The filter module 335 may filter the second maximum back pressure instance with the stored back pressure. The module 210 calculates the maximum back pressure and may regenerate the filter 150 if the maximum back pressure exceeds the pressure threshold.

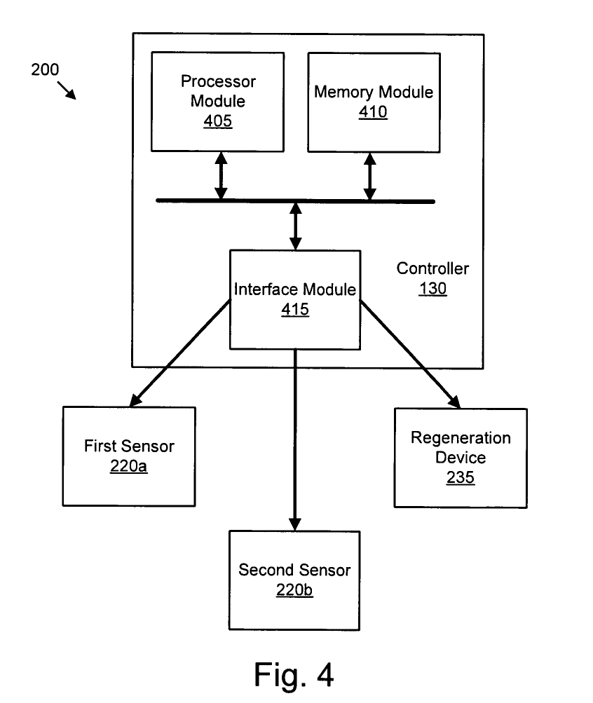

FIG. 4 is a schematic block diagram illustrating another embodiment of the control system 200 of FIG. 2. The controller 130 is depicted as comprising a processor module 405, memory module 410, and interface module 415. The processor module 405, memory module 410, and interface module 415 maybe fabricated of semiconductor gates on one or more semiconductor substrates. Each semiconductor substrate may be packaged in one or more semiconductor devices mounted on circuit cards. Connections between the processor module 405, the memory module 410, and the interface module 415 may be through semiconductor metal layers, substrate to substrate wiring, or circuit card traces or wires connecting the semiconductor devices.

The memory module 410 stores software instructions and data comprising one or more software processes. The processor module 405 executes the software processes as is well known to those skilled in the art. In one embodiment, the processor module 405 executes one or more software processes comprising the identification module 305, projection module 310, calculation module 315, test module 320, communication module 325, back pressure storage module 330, and filter module 335 of FIG. 3.

The processor module 405 may communicate with external devices and sensors such as the first and second sensor 220 and the regeneration device 225 of FIG. 2 through the interface module 415. For example, the first sensor module 220a may be a pressure sensor 126 such as a pressure sensor 126 of FIG. 1. The first sensor module 220a may communicate an analog signal representing a pressure value to the interface module 415. The interface module 415 may periodically convert the analog signal to a digital value and communicate the digital value to the processor module 405.

The interface module 215 may also receive one or more digital signals through a dedicated digital interface, a serial digital bus communicating a plurality of digital values, or the like. For example, the second sensor module 220b may be the air-flow sensor 156 of FIG. 1 and communicate a digital air flow value to the interface module 215. The interface module 215 may periodically communicate the digital air flow value to the processor module 405.

The processor module 405 may store digital values such as the pressure value and the air flow value in the memory module 410. In addition, the processor module 405 may employ the digital values in one or more calculations including calculations comprised by the identification module 305, projection module 310, calculation module 315, test module 320, communication module 325, back pressure storage module 330, and filter module 335. The processor module 405 may also control one or more devices such as the regeneration device 225 through the interface module 215.

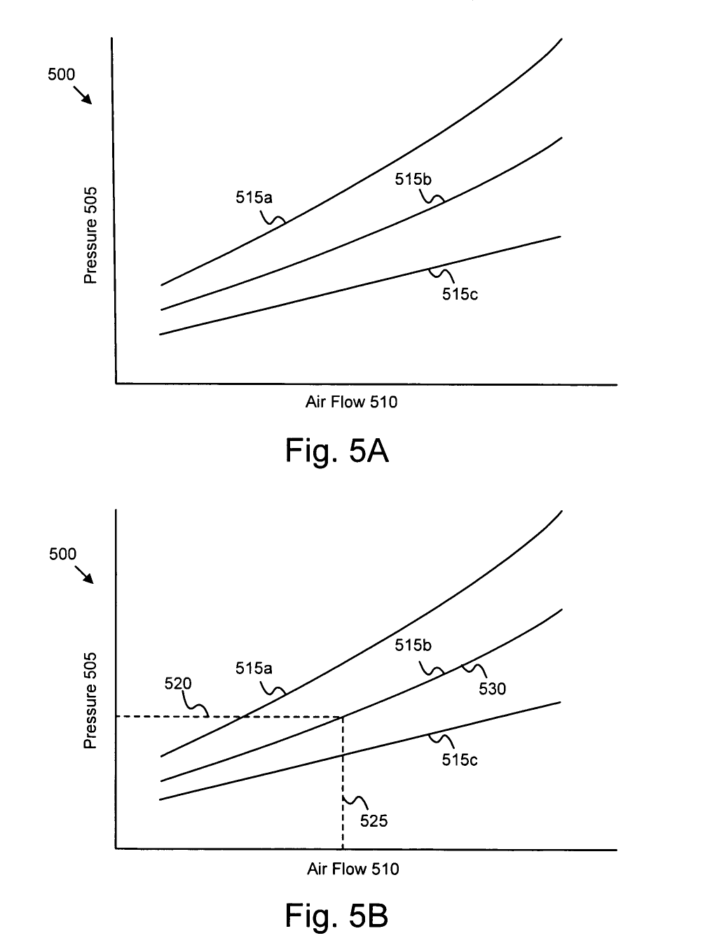

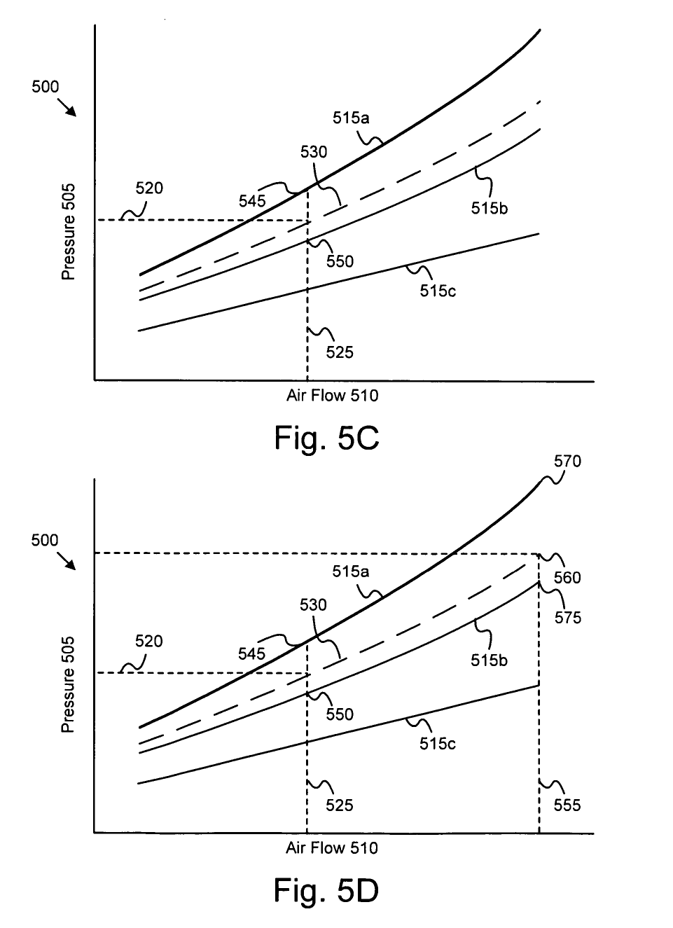

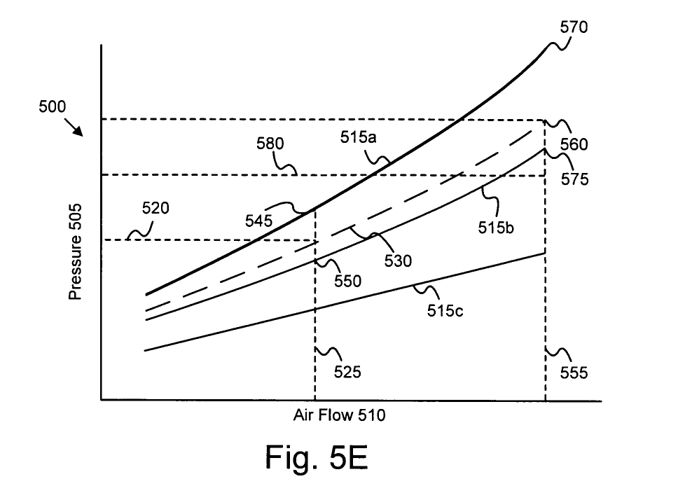

FIG. 5A is a graph 500 illustrating one embodiment of pressure functions 515 of the present invention. The pressure functions 515 may each comprise a plurality of air flow 510 and pressure 505 value pairs. The air flow 510/pressure 505 value pairs may be measured experimentally. In a certain embodiment, the differential pressure 505 value is a function of the air flow 510 value. The pressure 505 value maybe a linear function of the air flow 510 value. In an alternate embodiment, each pressure function 515 may be derived from a filter performance model.

FIG. 5B is a graph 500 illustrating one embodiment of identifying a target pressure function 530 of the present invention. The pressure functions 515 depicted maybe the pressure functions 515 of FIG. 5A. In addition, a specified pressure value 520 and a specified air flow value 525 are depicted. The pressure value 520 and air flow value 525 are a pair comprised by a single second pressure function 515b. In one embodiment, the identification module 305 of FIG. 3 identifies the second pressure function 515b as the target pressure function 530 for calculating the maximum back pressure because the second pressure function 515b comprises the pressure value 520 and the air flow value 525.

FIG. 5C is a graph 500 illustrating one embodiment of interpolating a target pressure function 530 from a first and second pressure function 515a, 515b of the present invention. The pressure functions 515 may be the pressure functions 515 of FIG. 5A and 5B with a specified pressure value 520 and a specified air flow value 525. The pressure value 520 and air flow value 525 pair are not comprised by a single pressure function 515.

In the depicted embodiment, a target pressure function 530 is interpolated from the first and second pressure function 515a, 515b. In an alternate embodiment, the target pressure function 530 is interpolated from a single pressure function 515 such as the first or second pressure function 515a, 515b. The interpolated pressure function 530 comprises the pressure value 520 and air flow value 525 pair.

In one embodiment, the pressure P as a function of air flow 510 A for the interpolated target pressure function 530 is calculated using Equation 1 where P₁ is the pressure value 520 for the input air flow value 525, P₁₁, is the pressure value 550 corresponding to the air flow value 525 for the second pressure function 515b, P₂₁ is the pressure value 545 corresponding to the specified air flow value 525 for the first pressure function 515a, P₁₂ is the pressure value 505 of the second pressure function 515b for any air flow 510 A, and P₂₂ is the pressure value 505 of the first pressure function 515a for the air flow 510A.

$$P ( A ) = {P}_{12} + ( {P}_{22} - {P}_{12} ) \times ( \frac{{P}_{1} - {P}_{11}}{{P}_{21} - {P}_{11}} ) \qquad Equation 1$$

FIG. 5D is a graph 500 illustrating one embodiment of calculating a maximum back pressure 560 of the present invention. The graph 500 of FIGS. 5A-5C is depicted. In addition, a high air flow 555 is depicted. The high air flow 555 may be the air flow required by an engine 110 such as the engine 110 of FIG. 1 when operating at a rated power. The high air flow 555 is projected for a target pressure function 530, yielding a maximum back pressure 560.

The high air flow 555 is projected for the target pressure function 530 by finding the air flow 510/pressure 505 value pair of the target pressure function 530 with an air flow 510 substantially equal to the high air flow 555. In one embodiment, the maximum back pressure 560 is the pressure for the air flow 510/pressure 505 value pair of the target pressure function 530 where the air flow 510 is substantially equal to the high air flow 555.

In a certain embodiment, the maximum back pressure 560 is calculated using Equation 1 where P₁ is the pressure value 520 for the input air flow value 525, P₁ is the pressure value 550 corresponding to the air flow value 525 for the second pressure function 515b, P₂₁, is the pressure value 545 corresponding to the specified air flow value 525 for the first pressure function 515a, P₁₂ is the pressure value 575 of the second pressure function 515b corresponding to the high air flow 555, and P₂₂ is the pressure value 570 corresponding to the first pressure function 515a for the high air flow 555.

FIG. 5E is a graph 500 illustrating one embodiment of testing a maximum back pressure 560 of the present invention. The graph 500 is the graph 500 of FIGS. 5A-5D. In addition, a pressure threshold 580 is shown. The maximum back pressure 560 exceeds the pressure threshold 580, indicating that a filter 150 such as the filter 150 of FIG. 1 will create too much back pressure at the high air flow 555 for an engine 110 such as the engine 110 of FIG. 1.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

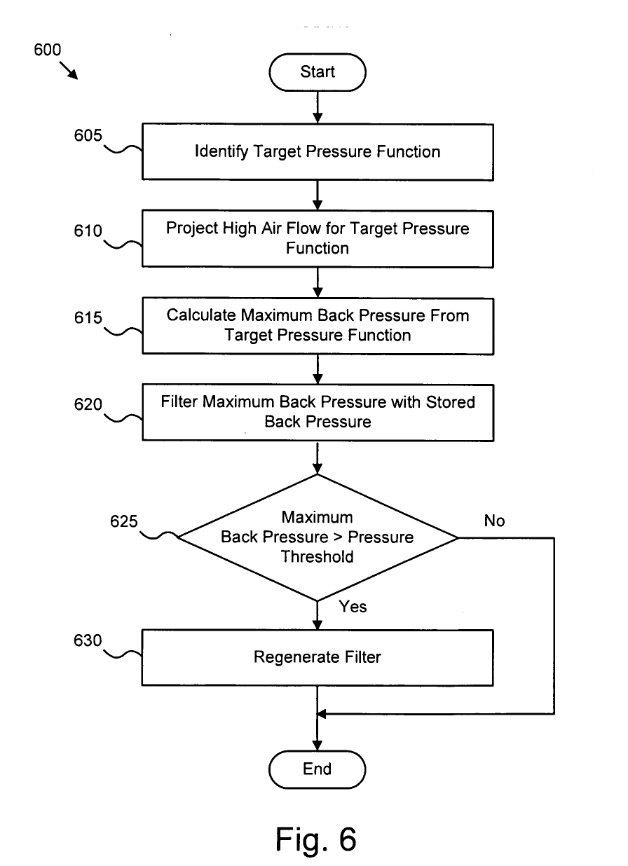

FIG. 6 is a schematic flow chart diagram illustrating one embodiment of a back pressure calculation method 600 of the present invention. The method 600 substantially includes the steps necessary to carry out the functions presented above with respect to the operation of the described apparatus 200, 300, 400 and system 100 of FIGS. 1-4. In addition the method 600 references elements of FIGS. 1-5.

The method 600 begins and an identification module 305 identifies 605 a target pressure function 530 for an air flow 510 and a pressure 505. In one embodiment, the identification module 605 identifies 605 the target pressure function 530 from a plurality of pressure functions. 515 where the target pressure function 530 comprises an air flow 510/pressure 505 value pair that is substantially equal to the air flow 510 and pressure 505, such as is illustrated in FIG. 5B. The identification module 605 may also interpolate the target pressure function 530 from one or more pressure functions 515, such as is illustrated in FIG. 5B. In an alternate embodiment, the identification module 605 derives the target pressure function 530 from a mathematical model, such as a gas flow model of a filter 150 such as the filter 150 of FIG. 1.

A projection module 310 projects 610 a high air flow 555 for the target pressure function 530. In one embodiment, the target pressure function 530 yields a pressure 505 as a function of an air flow 510. The projection module 310 may project the high air flow 555 by identifying the air flow 510 of the target pressure function 530 that is substantially equal to the high air flow 555. In an alternate embodiment, the projection module 310 projects the high air flow 555 on a second and a third pressure function 515b, 515c, such as is illustrated in FIG. 5D.

A calculation module 315 calculates 615 a maximum back pressure 560 from the target pressure function 530 for the high air flow 555. In one embodiment, the maximum back pressure is the pressure 505 yielded from the target pressure function 530 where the air flow 510 is the high air flow 555. In an alternate embodiment, the maximum back pressure is interpolated from the pressures 505 calculated from the second and third pressure functions 515b, 515c using the high air flow 555 as the air flow 510.

In one embodiment, a filter module 335 filters 620 the maximum back pressure 560 with a stored back pressure, yielding a filtered maximum back pressure. The back pressure storage module 330 of FIG. 3 stores the stored back pressure. In a certain embodiment, the memory module 410 of FIG. 4 comprises the back pressure storage module 330. In one embodiment, the filtered maximum back pressure is maximum back pressure 560 if the maximum back pressure 560 exceeds the stored back pressure, else the filtered maximum back pressure is the stored back pressure.

In one embodiment, a test module 320 determines 625 if the maximum back pressure 560 exceeds a pressure threshold 580. The pressure threshold 580 may be a percentage of a specified back pressure limit wherein the specified back pressure limit is the greatest back pressure an engine 110 can tolerate while delivering a rated power. In a certain embodiment, the maximum back pressure used is the filtered maximum back pressure of step 625. If the maximum back pressure 560 exceeds the pressure threshold 580, the test module 320 may regenerate 630 a filter 150 and the method 600 terminates. The test module 320 may regenerate 630 the filter 150 by directing the regeneration device 225 of FIG. 2 to regenerate the filter 150. If the maximum back pressure 560 does not exceed the pressure threshold 580, the method 600 terminates. The method 600 calculates 615 the maximum back pressure 560 and may regenerate the filter 150 if the maximum back pressure 560 exceeds the pressure threshold 580.

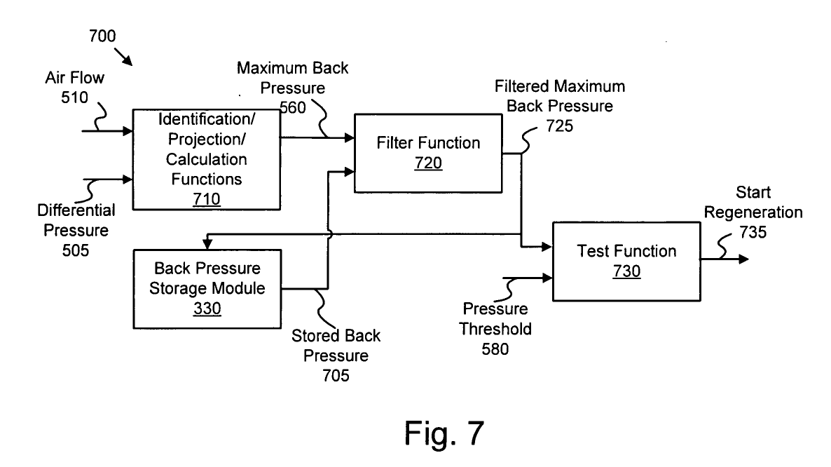

FIG. 7 is a schematic block diagram illustrating one embodiment of a maximum back pressure calculation process 700 of the present invention. The process 700 substantially includes the steps necessary to carry out the functions presented above with respect to the operation of the described method 600, apparatus 200, 300, 400, and system 100 of FIGS. 1-4, and 6. In addition the process 700 references elements of FIGS. 1-6.

The identifying, projecting, and calculating functions 710 described in steps 605, 610, and 615 of FIG. 6 receive an air flow 510 and a pressure 505 input. The functions 710 further yield a maximum back pressure 560. The filter function 720 described in step 620 of FIG. 6 filters the maximum back pressure 560 with a stored back pressure 705. The back pressure storage module 330 of FIG. 3 stores the stored back pressure 705. The filter function 720 described in step 620 of FIG. 6 yields a filtered maximum back pressure 725. The back pressure storage module 330 stores the filtered maximum back pressure 725 as the stored back pressure 705.

The test function 730 described in steps 625 and 630 of FIG. 6 determines if the filtered maximum back pressure 725 exceeds a pressure threshold 580 and generates a start regeneration directive 735 if the filtered maximum back pressure 725 exceeds the pressure threshold 580. The process 800 determines a filtered maximum back pressure 725 and issues the start regeneration directive 735 regenerating a filter 150 if the filtered maximum back pressure exceeds the pressure threshold 580.

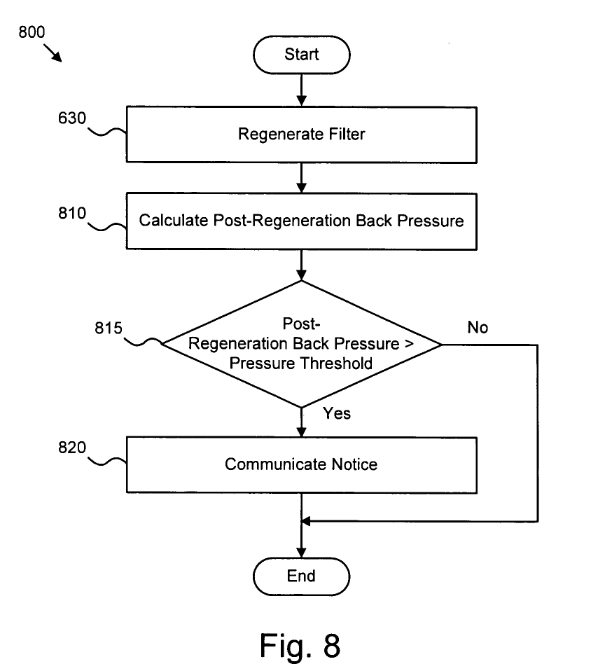

FIG. 8 is a schematic flow chart diagram illustrating one embodiment of a regeneration method of the present invention. The method 800 substantially includes the steps necessary to carry out the functions presented above with respect to the operation of the described apparatus 200, 300, 400 and system 100 of FIGS. 1-4. In addition the method 800 references elements of FIGS. 1-5.

The method 800 begins and a test module 320 regenerates 630 a filter 150 such as in step 630 of FIG. 6. In one embodiment, an identification module 305, projection module 310, and calculation module 315 calculates 810 a post-regeneration back pressure from an air flow 510 and pressure 505 measured or derived subsequent to the regeneration 630 of the filter 150. The identification module 305, projection module 310, and calculation module 315 may calculate 810 the post-regeneration back pressure as described in steps 605, 610, and 615 of FIG. 6.

A test module 320 determines 815 if the post-regeneration back pressure exceeds a pressure threshold 580 such as the pressure threshold 580 of FIG. 5E. If the post-regeneration back pressure does not exceed the pressure threshold 580, the method 800 terminates. If the post-regeneration back pressure exceeds the pressure threshold 580, a communication module 325 may communicate 820 a notice and the method 800 terminates. The notice may indicate that the filter 150 cannot support a rated power of an engine 110. The notice may further recommend that the filter 150 be serviced and/or replaced.

In one embodiment, the communication module 325 communicates 820 the notice by asserting a warning light. For example, the communication module 325 may assert or illuminate a dashboard warning light. In an alternate embodiment, the communication module 325 writes the notice to a memory such as the memory module 410 of FIG. 4. The notice may comprise one or more specified data words. The notice maybe retrieved from the memory module 410 during a service check such as when a controller 130 is connected to a diagnostic device.

The embodiment of the present invention calculates 615 a maximum back pressure 560 for a filter 150. In addition, the embodiment of the present invention may regenerate 630 the filter 150 if the maximum back pressure 560 exceeds a pressure threshold 580. The present invention maybe embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to calculate maximum back pressure, the apparatus comprising:
an identification module configured to identify a target pressure function for an air flow and a pressure;
a projection module configured to project an air flow for the target pressure function; and
a calculation module configured to calculate a maximum back pressure from the target pressure function for the air flow.

2. The apparatus of claim 1, further comprising a test module configured to regenerate a filter if the maximum back pressure exceeds a pressure threshold.

3. The apparatus of claim 2, wherein the identification module, projection module, and calculation module are further configured to calculate a post-regeneration back pressure subsequent to regenerating the filter.

4. The apparatus of claim 3, further comprising a communication module configured to communicate a notice if the post-regeneration back pressure exceeds the pressure threshold.

5. The apparatus of claim 1, further comprising a filter module configured to filter the maximum back pressure with a stored back pressure.

6. The apparatus of claim 1, wherein the target pressure function comprises a plurality of measured air flow and pressure value pairs.

7. The apparatus of claim 1, wherein the high air flow is specified for a rated maximum power of an engine.

8. A method for calculating a maximum back pressure, the method comprising:
identifying a target pressure function for an air flow and a pressure;
projecting an air flow for the target pressure function; and
calculating a maximum back pressure from the target pressure function for the air flow.

9. The method of claim 8, wherein the method further comprises regenerating a filter if the maximum back pressure exceeds a pressure threshold.

10. The method of claim 9, further comprising calculating a post-regeneration back pressure subsequent to regenerating the filter.

11. The method of claim 10, further comprising communicating a notice if the post-regeneration back pressure exceeds the pressure threshold.

12. The method of claim 8, further comprising filtering the maximum back pressure with a stored back pressure.

13. The method of claim 8, wherein the target pressure function comprises a plurality of measured air flow and pressure value pairs.

14. The method of claim 8, wherein the target pressure function is interpolated from a second and third pressure function.

15. The method of claim 8, wherein the high air flow is specified for a rated maximum power of an engine.

16. A signal bearing medium tangibly embodying a program of machine-readable instructions executable by a digital processing apparatus to perform an operation to calculate a maximum back pressure, the operation comprising:
identifying a target pressure function for an air flow and a pressure;
projecting an air flow for the target pressure function; and
calculating a maximum back pressure from the target pressure function for the air flow.

17. The signal bearing medium of claim 16, wherein the instructions further comprise an operation to regenerate a filter if the maximum back pressure exceeds a pressure threshold.

18. The signal bearing medium of claim 17, wherein the instructions further comprise an operation to calculate a post-regeneration back pressure subsequent to regenerating the filter.

19. The signal bearing medium of claim 18, wherein the instructions further comprise an operation to communicate a notice if the post-regeneration back pressure exceeds the pressure threshold.

20. The signal bearing medium of claim 16, wherein the target pressure function comprises a plurality of measured air flow and pressure value pairs and wherein the instructions further comprise an operation to interpolate the target pressure function from a second and third pressure function.

21. A system to calculate maximum back pressure, the system comprising:
a filter configured to remove particulates from an exhaust gas flow;
a pressure sensor module configured to determine a pressure across the filter;
an air-flow sensor module configured to determine an air flow through the filter; and
a controller comprising
an identification module configured to identify a target pressure function for the air flow and the pressure;
a projection module configured to project air flow for the target pressure function; and
a calculation module configured to calculate a maximum back pressure from the target pressure function for the air flow.

22. The system of claim 21, further comprising a test module configured to regenerate the filter if the maximum back pressure exceeds a pressure threshold.

23. The system of claim 22, further comprising a diesel engine and exhaust gas after-treatment system.

24. The system of claim 23, wherein the high air flow is specified for a rated maximum power of the diesel engine.

25. An apparatus to calculate a maximum back pressure, the apparatus comprising:
means for identifying a target pressure function for an air flow and a pressure;
means for projecting an air flow for the target pressure function;
means for calculating a maximum back pressure from the target pressure function for the air flow; and
means for regenerating a filter if the maximum back pressure exceeds a pressure threshold.
